(19) United States
(12) Patent Application Publication
(10) Pub. No.: US 2026/0359272 A1
(43) Pub. Date: Nov. 12, 2026

(54) SYSTEM AND METHOD FOR UNIFIED MANAGEMENT OF URBAN WEATHER DATABASE BASED ON PYTHON

(71) Applicant: National Institute of Meteorological Sciences, Seogwipo-si (KR)

(72) Inventors: Dong Won YI, Seoul (KR); Hee Wook CHOI, Seogwipo-si (KR); Seung Wook LEE, Seogwipo-si (KR); Sung Hwa PARK, Seogwipo-si (KR)

(21) Appl. No.: 19/571,271

(22) Filed: Mar. 18, 2026

Related U.S. Application Data
(63) Continuation-in-part of application No. 17/973,434, filed on Oct. 25, 2022, now abandoned.

(30) Foreign Application Priority Data
Oct. 26, 2021 (KR) 10-2021-0143209

(51) Int. Cl. G06F 16/215; G06F 16/22

(52) U.S. Cl. CPC G06F 16/215; G06F 16/221

(57) ABSTRACT

Disclosed is a Python-based integrated management method of an urban customized weather database for constructing urban weather observation data as an integrated database. The method includes the steps of: storing raw urban weather observation data collected from a plurality of urban weather observation networks as first files in a predetermined format according to an order of observation time at each observation point of the plurality of urban weather observation networks; extracting data of each observation point of the plurality of urban weather observation networks from the first files, obtained by the storing, according to the order of observation time for a predetermined weather element and analysis period; masking observation values belonging to a predetermined masking condition, among observation values included in the extracted data; and storing the masked data as a second file.

### CROSS REFERENCE TO RELATED APPLICATION OF THE DISCLOSURE

This application is a continuation-in-part of U.S. Nonprovisional application Ser. No. 17/973,434, filed on 2022 Oct. 25. The present application also claims the benefit of Korean Patent Application No. 10-2021-0143209 filed in the Korean Intellectual Property Office on Oct. 26, 2021, the entire contents of which are incorporated herein by reference.

### BACKGROUND OF THE DISCLOSURE

### Field of the Disclosure

The present disclosure relates to an integrated management method and system of a weather database, and more particularly, to an integrated management method and system of an urban customized weather database

### Background of the Related Art

In modern times, as industrialization and urbanization progress in many countries, the number of people living in cities has increased significantly. In the cities of a large population, social and economic damage occurs every year due to abnormal meteorological phenomena. In addition, meteorological phenomena such as heat waves and cold waves are affecting a demand for heating and cooling in Korea, which is located in a mid-latitude region with distinct seasonal characteristics, and efficiency of using the heating and cooling. Accordingly, it is important to accurately analyze meteorological phenomena of a medium or less scale occurring in cities, predict future urban meteorological phenomena based on such urban meteorological data, or control urban infrastructures.

Recently, the National Institute of Meteorological Sciences in Korea has constructed observation networks that may measure various meteorological variables in major metropolitan areas such as Seoul, Gyeonggi-do, and the like, and is making efforts to provide accurate observation data on the urban meteorological phenomena.

However, these observation networks have different types of data collected from each observation network and there is a difference in contents of collected and stored data. Thus, there is a limit in that the overall urban weather observation data is difficult to access, and its utilization is low.

### SUMMARY OF THE DISCLOSURE

An object of the present disclosure is to provide a method and system for constructing an urban customized weather database that consistently stores data of different urban weather observation networks, and managing the database in an integrated manner.

To accomplish the object, according to one aspect of the present disclosure, there is provided Python-based integrated management method of an urban customized weather database, the method for constructing urban weather observation data into an integrated database and including the steps of: storing raw urban weather observation data collected from a plurality of urban weather observation networks as first files in a predetermined format according to an order of observation time at each observation point of the plurality of urban weather observation networks; extracting data of each observation point of the plurality of urban weather observation networks from the first files, obtained by the storing, according to the order of observation time for a predetermined weather element and analysis period; masking observation values corresponding to predetermined masking conditions among observation values included in the extracted data and calculating a time-series integrity index; for the masked data, generating a reliability index by calculating a ratio of the masked observation values among all observation values; and storing the masked data including the time-series integrity index and the reliability index as a second file.

In an embodiment, the plurality of urban weather observation networks may include a road weather information (RWI) observation network, a surface energy balance (SEB) observation network, an integrated meteorological sensor (IMS) observation network, and an urban-boundary-green (UBG) observation network each operated by the National Institute of Meteorological Sciences.

In an embodiment, the raw urban weather observation data may include data that, when observation variable names are defined differently depending on the plurality of urban weather observation networks, have been converted into standardized variable names based on a predefined mapping table.

In an embodiment, the predetermined format may include a comma separated value (CSV) format.

In an embodiment, the first files may be stored in a plurality in correspondence with a number (nxy) obtained by multiplying a number (n) of all observation points included in the plurality of urban weather observation networks by a number (y) of observation periods on a yearly basis.

The predetermined masking conditions may include: when the predetermined weather element is wind speed, masking, as missing values, a negative observation value, a value exceeding 75, and a values with a difference exceeding 10 compared to an immediately preceding observation value among the observation values; when the predetermined weather element is temperature, masking, as missing values, observation values less than −90 and observation values exceeding 60 among the observation values, each in correspondence with a thermometer calibration failure; and when the predetermined weather element is not wind speed and temperature, masking negative observation values among the observation values as missing values.

In an embodiment, the predetermined weather element may include at least one weather element selected from a group consisting of: air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, and daily maximum wind direction.

In an embodiment, the predetermined analysis period may include a yearly-based period.

In one embodiment, the yearly-based period may be set based on a minute-unit temporal resolution from 00:00 on January 1 to 23:59 on December 31 of a corresponding year.

In an embodiment, the step of storing as the first files in the predetermined format according to an order of observation time may include the step of, when a plurality of observation values are present at each observation point with respect to one weather element at a same observation time, storing only an observation value among the plurality of observation values with respect to the one weather element, and the step of removing observation data out of a time-series order based on time information for each observation point.

A computing system according to an embodiment of the present disclosure is configured to implement a Python-based integrated management method of an urban customized weather database for constructing urban weather observation data into an integrated database.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a view showing geographic distribution of urban weather observation networks used in an integrated management method of an urban customized weather database according to an embodiment of the present disclosure;

FIGS. 2 to 5 are views showing raw data configurations of the urban weather observation networks used in the integrated management method of the urban customized weather database according to an embodiment of the present disclosure;

FIG. 6 is a flowchart illustrating the integrated management method of the urban customized weather database according to an embodiment of the present disclosure;

FIG. 7 is a view conceptually showing the integrated management method of the urban customized weather database according to an embodiment of the present disclosure;

FIG. 8 is a view conceptually showing an architecture of the urban customized weather database integrated using the integrated management method of the urban customized weather database according to an embodiment of the present disclosure;

FIG. 9 is a view showing one example of a weather element database constructed according to the integrated management method of the urban customized weather database according to an embodiment of the present disclosure; and

FIGS. 10a and 10b is a view showing a Python-based pseudo code for implementing the integrated management method of the urban customized weather database according to an embodiment of the present disclosure.

### DETAILED DESCRIPTION OF THE PREFERRED EMBODIMENT

Hereinafter, embodiments of the present disclosure will be described in detail with reference to the accompanying drawings.

The terms used throughout the present disclosure may have a meaning of a nuance suggested or implied in the context beyond the meaning mentioned explicitly.

Phrases such as “in one embodiment” and “in an exemplary embodiment” used in this disclosure do not necessarily refer to the same embodiment, and phrases such as “in another embodiment” or “in another exemplary embodiment” may or may not necessarily refer to another embodiment.

The terms such as “and”, “or”, and “and/or” used in this disclosure may include various meanings that may depend, at least in part, on the context in which such terms are used.

According at least in part to the context, the term such as “one or more” used in this disclosure may be used to describe an arbitrary feature, structure, or characteristic in a singular sense, or may be used to refer to a feature, a structure, or a combination of these in a plural sense.

In addition, the terms such as “based on”, “in reaction to”, and “in response to” are not intended to transfer a set of exclusive factors, but to permit presence of an additional factor that is not explicitly stated, according at least in part to the context.

In addition, expressions such as “first” and “second” used in the present disclosure may modify various components regardless of the order and/or importance, and are only used to distinguish one component from another, and do not limit the components.

Unless defined otherwise, all technical and scientific terms used in this disclosure have the same meaning as commonly understood by those skilled in the art.

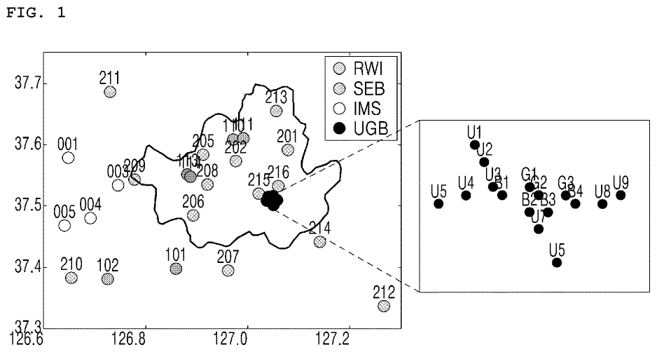

FIG. 1 is a view showing geographic distribution of urban weather observation networks used in an integrated management method of an urban customized weather database according to an embodiment of the present disclosure.

Referring to FIG. 1, the National Institute of Meteorological Sciences in Korea has operated observation devices configured to measure various weather elements (air temperature, humidity, wind direction, wind speed, air pressure, precipitation, etc.) at a plurality of locations in Seoul and metropolitan areas since 2018. These observation networks configured to acquire weather data in urban areas with high-spatial resolution include a road weather information (RWI) observation network, a surface energy balance (SEB) observation network, an integrated meteorological sensor (IMS) observation network, and an urban-boundary-green (UBG) observation network. In detail, the road weather information (RWI) observation network is an observation network installed and operated on and around road surfaces to observe and analyze urban road weather characteristics. The surface energy balance (SEB) observation network is a network installed and operated on rooftops of buildings and houses within the metropolitan areas to focus on analysis of characteristics such as urban energy balance (net heat flux), and the like. The integrated meteorological sensor (IMS) observation network is an observation network installed and operated on traffic lights and streetlights in urban areas to monitor urban weather. The urban-boundary-green (UBG) observation network an observation network installed and operated on surrounding roads and within city parks to observe and analyze weather environmental characteristics around urban green spaces. Locations of observation points of each observation network are presented in Table 1.

TABLE 1

| Identification | Observation | Observation | | |
|---|---|---|---|---|
| number | network | point ID | Latitude | Longitude |
| 1 | RWI | 101 | 37.3969 | 126.8602 |
| 2 | RWI | 102 | 37.3805 | 126.7265 |
| 3 | RWI | 110 | 37.6068 | 126.9738 |
| 4 | RWI | 111 | 37.6096 | 126.9919 |
| 5 | RWI | 113 | 37.5510 | 126.8833 |
| . . . | . . . | . . . | . . . | . . . |
| 36 | UBG | U5 | 37.508 | 127.038 |
| 37 | UBG | U6 | 37.501 | 127.051 |
| 38 | UBG | U7 | 37.505 | 127.049 |
| 39 | UBG | U8 | 37.508 | 127.056 |
| 40 | UBG | U9 | 37.509 | 127.058 |

These observation networks are configured to observe basic elements needed for weather observation in common, such as air temperature, humidity, wind direction, and wind speed, while observing additional weather elements different from each other according to an operating purpose of each observation network. For example, the RWI observation network is configured to observe air temperature, wind direction, wind speed, maximum wind direction, maximum wind speed, daily precipitation, air pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, and the like.

For example, the SEB observation network is configured to observe air pressure, rainfall, infrared surface temperature, contact-type surface temperature (south), contact-type surface temperature (north), upward shortwave radiation, downward shortwave radiation, upward longwave radiation, downward longwave radiation, net shortwave radiation, net longwave radiation, net radiation, albedo, net radiometer temperature, air temperature, humidity, water vapor pressure, wind direction, wind speed, instantaneous maximum wind speed, soil heat flux, soil temperature, and soil moisture, and the like.

For example, the IMS observation network is configured to observe air pressure, air temperature, humidity, wind direction, wind speed, rainfall, and the like.

For example, the UBG observation network is configured to observe average wind direction per minute, maximum wind direction, average wind speed per minute, average wind speed, maximum wind speed, air temperature, humidity, air pressure, soil moisture, soil average temperature, average net radiation, net radiation, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, daily maximum wind direction, and the like.

Observation data obtained from such observation networks are transmitted to and accumulated in a server managed by the National Institute of Meteorological Sciences according to a data collection type and method of each observation network.

However, due to differences in installation purposes and device manufacturers, a plurality of the urban weather observation networks have heterogeneous header structures such that the respective observation networks use different variable names even for observation variables representing a same physical quantity. For example, air pressure may be defined differently, i.e., as “P” in the SEB observation network, “P 1” in the IMS observation network, and “Air_P” in the RWI observation network, and air temperature may be defined differently, i.e., as “T 1” in the SEB observation network, “airtemp” in the UBG observation network, and “Air_T” in the RWI observation network. Thus, in a database system in the related art, there has been a problem in that when a plurality of pieces of observation network data are to be integrated and retrieved, a variable name for each observation network needs to be identified separately and format conversion processing needs to be additionally performed for each retrieval. This corresponds to a technical problem in computer processing such that unnecessary computational operations are increased during database retrieval and efficiency in data access is worsened.

Additionally, in raw data collected from the plurality of observation networks, time-series instability issues such as redundant reception of multiple observation values at same observation time or inclusion of records with a reversed temporal order occur due to data communication errors, temporary malfunctions of an observation device, or network delays. When such time-series unstable data is stored in a database as-is, index errors, distortion of calculation results, or system exceptions may occur during subsequent time-series-based analysis. Therefore, ensuring structural stability of databases remains a problem that needs to be solved in a field of computer technology.

Further, in a case of urban weather data observed in units of minutes, when large-scale time series data corresponding to 40 observation points×525, 600 minute-level time indices per year is managed in a single file or single structure, computer resource management problems such as file input/output speed deterioration, a sharp increase in memory usage, and inability to selectively reprocess data for particular years occur. To solve such technical problems, a database architecture configured to efficiently structure, store, and process large-scale time-series data needs to be designed.

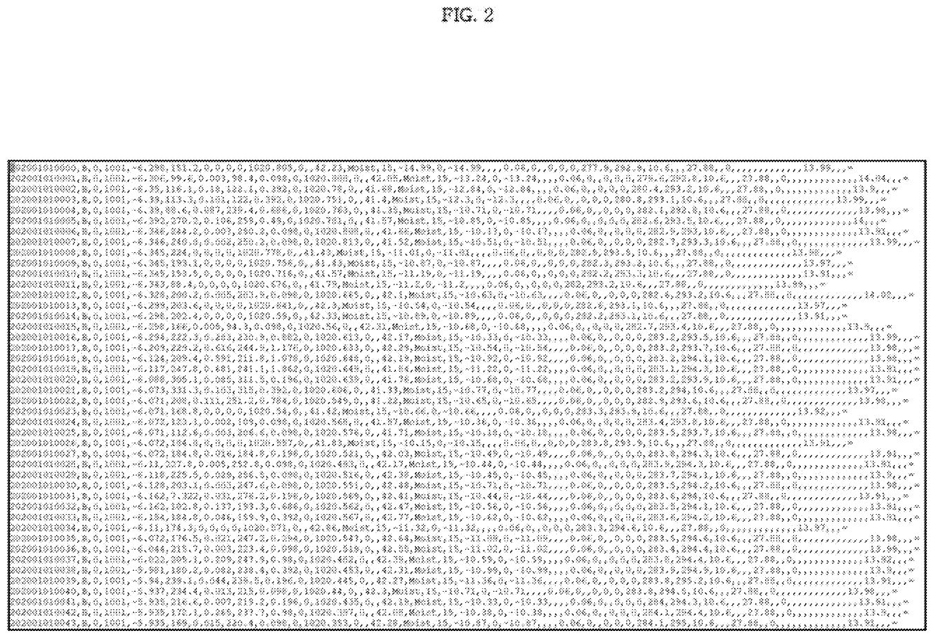

FIGS. 2 to 5 are views showing raw data configurations of the urban weather observation networks used in the integrated management method of the urban customized weather database according to an embodiment of the present disclosure.

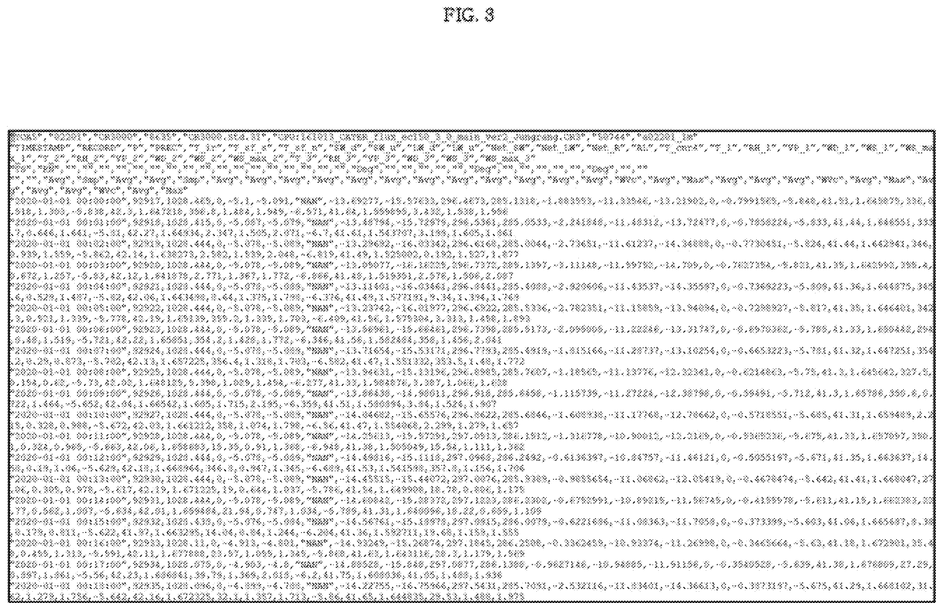

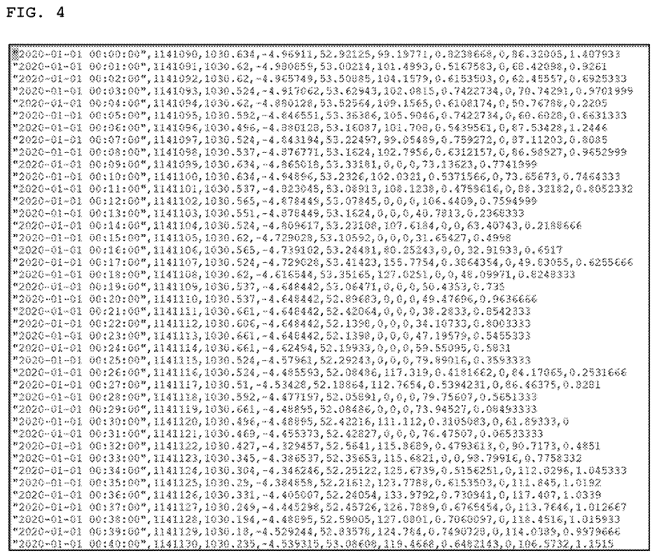

FIG. 2 illustrates one example of observation data collected from the RWI observation network. FIG. 3 illustrates one example of observation data collected from the SEB observation network. FIG. 4 illustrates one example of observation data collected from the IMS observation network. FIG. 5 illustrates one example of observation data collected from the UBG observation network. Referring to FIGS. 2 to 5, formats of the observation data collected from the observation networks, respectively, are different from each other. Therefore, for example, when geographical distribution of air temperature is to be analyzed using urban weather observation data at observation points in Seoul and metropolitan areas, there is a problem in that such different observation data needs to be separately collected and processed.

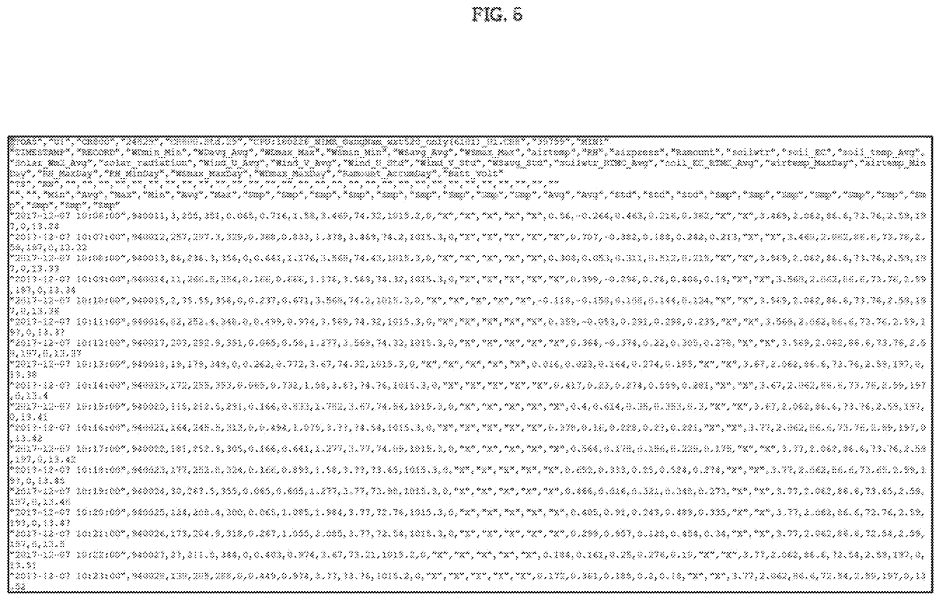

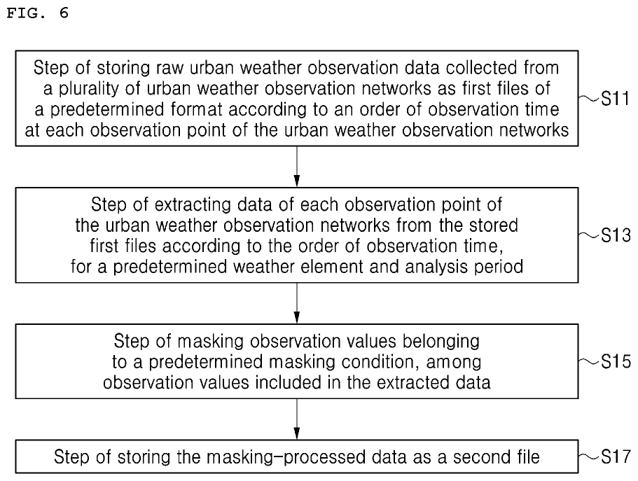

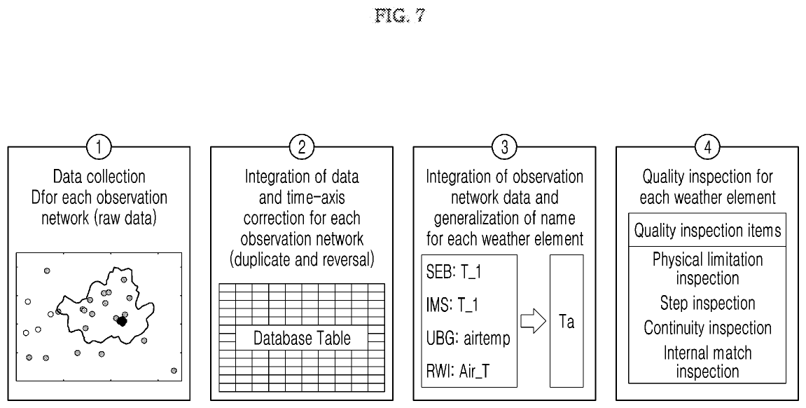

FIG. 6 is a flowchart illustrating the integrated management method of the urban customized weather database according to an embodiment of the present disclosure. FIG. 7 is a view conceptually showing the integrated management method of the urban customized weather database according to an embodiment of the present disclosure.

Referring to FIGS. 6 and 7, the integrated management method of the urban customized weather database according to an embodiment of the present disclosure is a Python-based integrated management method of an urban customized weather database for constructing urban weather observation data as an integrated database. The method includes the steps of: storing raw urban weather observation data collected from a plurality of urban weather observation networks as first files in a predetermined format according to an order of observation time at each observation point of the urban weather observation networks (S11); extracting data for each observation point of the urban weather observation networks from the first files, obtained by the storing, according to the order of observation time with respect to a predetermined weather element and analysis period (S13); masking observation values corresponding to a predetermined masking condition, among observation values included in the extracted data (S15); and storing data, obtained by the masking, as one second file (S17).

The method according to an embodiment of the present disclosure provides an improvement in computer functions such that a format conversion operation step is removed during database retrieval compared to the related art, by reconstructing a plurality of pieces of urban weather observation network data having heterogeneous header structures into a unified columnar structure that allows direct merging and querying without additional format conversion. In addition, a database structure configured to improve an input/output speed and memory efficiency of large-scale time-series data is implemented by applying a standardized time-axis index (timestamp) based on a minute-level temporal resolution and separating and storing the large-scale time-series data in units of files for each year. Further, by performing masking based on domain-specific rules for automatically detecting signs of malfunction in physical sensors, automated data quality management which cannot be consistently applied in real time throughout large-scale minute-level time-series data using a method manually performed by human is realized.

At step S11, the raw urban weather observation data collected from the plurality of urban weather observation networks may be stored as the first files in a predetermined format according to the order of observation time at each observation point of the urban weather observation networks. The plurality of urban weather observation networks may include a road weather information (RWI) observation network, a surface energy balance (SEB) observation network, an integrated meteorological sensor (IMS) observation network, and an urban-boundary-green (UBG) observation network each operated by the National Institute of Meteorological Sciences.

At this time, the raw urban weather observation data collected from the urban weather observation networks may include variables corresponding to weather elements and information of observation points constituting a corresponding urban weather observation network (e.g., an observation point identification (ID)). The weather elements and the observation point information may be included in a header portion of the first files.

The raw urban weather observation data may be defined with different variable names in spite of a same physical quantity due to differences in device configurations and operational purposes for respective observation networks. In the present embodiment, variable names may be converted into standardized variable names with reference to a predefined mapping raw variable names correspond to the standardized variable names for each observation network. The mapping table may be stored separately for each observation network, and the standardized variable names may be arranged in a common header schema to enable integrated analysis between observation networks. In addition, when a particular name of a variable included in raw data does is not present in the mapping table or a correspondence relationship is unclear, an observation value corresponding to the variable may be processed as a missing value or excluded according to a predefined exception handling rule to maintain consistency of an integrated database.

Standardization of variable names based on the mapping table is not limited to simple string substitution, but corresponds to a structural arrangement process for reconstructing different data structures according to observation networks into a single integrated analysis system. The urban weather observation networks include a surface energy balance observation network, an integrated meteorological sensor observation network, an urban-boundary-green observation network, and a road weather information observation network. Respective observation networks have different internal header structures due to differences in installation purposes and device configurations.

For example, air pressure is defined as “P” in the surface energy balance observation network, but aligned as “Pres” in a standardization system. In addition, as a multi-layer sensor structure is reflected, a plurality of temperature variables such as “T_1”, “T_2”, and “T_3” may be present in the same observation network. Wind speed may also be defined as such as “WS_1”, “WS_2”, or “WS_.” according to channels. In such cases, a common naming convention may be applied in a standardization process so that respective variables are recognized as variables in a same category in the integrated database while preserving physical meanings of the respective variables.

In a case of the integrated meteorological sensor observation network, suffix-based notation may be used such that air pressure is defined as “P_1” or relative humidity is defined as “RH_1.” In the standardization process, such suffix structures may be analyzed to be aligned into standard variable names based on physical quantities. However, even when the physical quantities are identical to each other, when measurement heights or sensor positions are different from each other, metadata may be maintained to identify such difference.

In the urban-boundary-green observation network, variable names specific to device manufacturers or data logging systems such as “airtemp”, “airpress”, “WDavg_Avg”, and “WSavg_Avg” may be used. In the standardization process, “airtemp” may be converted into an integrated temperature variable and “airpress” may be converted into an integrated pressure variable, and variables of average wind direction and average wind speed may also be aligned with variables of wind direction and wind speed in the integrated system. In particular, when daily maximum and minimum aggregate values are included, the daily maximum and minimum aggregate values may be managed as aggregate variables distinct from minute-level data to enable a data hierarchy to be established based on a temporal resolution.

In a case of the road weather information observation network, temporary variables for internal processing or undefined fields may be included. For example, items such as “tmp1”, “tmp2”, and “tmp3” may not be directly associated with actual physical quantities, and such variables are excluded during an integration process or separated into a separate log area. In addition, a variable such as “Air_T” having a same meaning as “T_1” in another observation network is converted into a standard temperature variable, and “Air_P” is aligned as a standardized pressure variable. Through this process, header structures across observation networks are reconfigured to have a same order and naming system.

A standardized header schema is not limited to unifying variable names, but also functions as a basis for determining a column structure of the integrated database. A final data structure may include a metadata area including information such as an observation point identifier, latitude, longitude, and altitude and an weather element area section arranged thereafter. The final data structure maintains consistency during processes of merging data between observation networks, combining data on a yearly basis, and performing extraction and reconstruction for each weather element.

In particular, in a case of wind information, since most observation networks directly provide only wind direction and wind speed, using this data as-is may result in limitations on statistical analysis and input into numerical models. In the present embodiment, extended weather elements may be generated by calculating orthogonal coordinate system components using wind direction and wind speed. Based on the wind speed and the wind direction, east-west components and north-south components may be calculated, and then, included as additional columns in the integrated database. Since this process is performed by applying a same computational algorithm to all observation networks, a possibility of comparison between observation networks is ensured.

In addition, average east-west wind and average north-south wind may be calculated using an average value in a certain time section, and east-west wind anomaly and north-south wind anomaly, in which temporal variability is reflected, as well as maximum and minimum wind speeds and gusts may be additionally calculated. Although such expanded variables obtained by the calculation are not present in the raw data, the expanded variables are generated and included during an integration step, and may be utilized for urban-scale wind flow analysis, improvement of wind input fields for safe operation of urban air mobility (UAM), development of building wind models in high-rise building areas, research on a heat island phenomenon, and analysis of pollutant diffusion.

As described above, data that has undergone such variable name standardization and expanded calculation processes is not merely a result of simple file merging, but reconfigured as an analysis-oriented database in which structural heterogeneity among observation networks is removed and a same time axis and a same variable system are shared. Standardization tables, variable correspondence rules, and expanded calculation algorithms may be implemented as Python-based modules, and may be flexibly expanded simply by modifying the mapping table even when an observation network is added or a variable system is changed.

As a result, a standardization structure for heterogeneous device data variable names and an extended algorithm for wind components according to the present embodiment function as a core technical configuration that simultaneously improves integration, reproducibility, scalability, and analytical usability of the urban customized weather database. This may operate as a foundational technology for providing a structured and highly reliable data infrastructure suitable for urban weather research, as well as a simple data storage technique.

Standardization processing on variable names based on the mapping table is fundamentally distinguished from mathematical calculations or simple string substitution. In a heterogeneous observation network data processing system in the related art, due to different header structures for respective observation networks, there has been such inefficiency that, when data from a plurality of observation networks is integrated and retrieved within a single database structure, an additional operation of dynamically mapping variable names for the respective observation network needs to be repeatedly performed for each retrieval. On the other hand, in the present embodiment, standardization of a variable name is performed in advance in the storage step so that data from all observation networks is stored in an integrated column structure in which a common header schema is shared. Accordingly, during subsequent processing of retrieval and analysis, direct access may be performed using a same standardized variable name regardless of an observation network. Therefore, a dynamic variable name mapping operation during database retrieval is removed to thereby improve computer processing efficiency. This constitutes a technical effect of improving computer functionality by improving a database structure, and is distinguished from an abstract concept of variable name generalization.

Accordingly, by accumulating raw urban weather observation data of any one observation network over an entire observation period, the raw urban weather observation data may be stored, for each observation point, as data in a format arranged in rows (weather elements) and columns (observation values according to observation time). At this time, the format of first files into which the raw urban weather observation data is stored may be a format such as a comma separated value (CSV), TXT, DAT, or the like.

In general, an observation time interval at the urban weather observation networks used in embodiments of the present disclosure may be 1 minute, 5 minutes, 10 minutes, 30 minutes, or the like. However, this may vary depending on an observation interval at the observation networks. For example, when a weather element is daily precipitation, observation values may be collected on a 24-hour basis.

In the present embodiment, a time-axis index which functions as a reference for a time series array for each observation point may be defined as a timestamp, and the timestamp may be generated in a predetermined time format including a year, a month, a day, an hour, a minute, and a second. The timestamp may be generated from time information included in raw data or assigned by converting a time field of the raw data, and data for each observation point may be sorted based on the timestamp and stored in the first files. As described above, by explicitly unifying a time axis reference, data collected from different observation networks may be merged and compared with each other based on a same time reference.

Time-series consistency correction based on the timestamp corresponds to not only storing raw observation data, but also a structural conversion of a state of the raw data such that a time axis array maintains a monotonically increasing structure. In detail, raw data from each observation point may be received in a state in which a time series is reversed or duplicate due to communication errors or the like. By converting such structurally unstable raw data into stable time series data having a monotonically increasing timestamp index as a reference axis, prerequisites for performing subsequent extraction of weather elements, masking processing, calculation of an integrity index, and time-axis-based merging of data from a plurality of observation points without errors are established. As such, unlike a general-uses data sorting algorithm, converting raw data into a structurally stable time-series state corresponds to specialized technical treatment for addressing specific structural problems of large-scale and minute-level time-series data from urban weather observation networks, i.e., duplicate reception at a same time point, time-series reversal due to communication errors, and inconsistency with a year-level reference time axis.

Meanwhile, step S11 may include the step of, when a plurality of observation values are present at a same observation time with respect to one weather element for each observation point, storing only one of the observation values for the weather element. That is, due to a data communication error or the like in an observation network, a plurality of observation values may be present at the same observation time with respect to weather elements collected from one observation point of the urban weather observation networks. In this case, only one observation value may be stored as data in the first files, and other observation values may be ignored. For example, when there are several pairs of observation values observed at the same observation time, only observation values collected first may be stored as data in the first file.

In addition, in the present embodiment, time series consistency correction for checking a temporal order based on the timestamp may be performed on data at each observation point. In detail, time series consistency correction may not only simply remove duplicates, but also function as a preprocessing step for standardizing a time axis and performing all subsequent processing based on the standardized time axis. In the present embodiment, after reading time information included in the raw data at each observation point, a process of time-axis standardization for redefining the time information as a common time-axis index may be performed. In detail, the time-axis index may be named as a timestamp and generated using a unified string format of year-month-day hour: minute: second, and consistency in time representation may be ensured by fixing a second unit to a constant value based on a minute-level resolution. The timestamp generated as described above is set as a primary index for data at each observation point and used as a reference axis in all subsequent processes including data sorting, extraction, and merging.

After the time-axis standardization is completed, a procedure for automatically checking and correcting duplication and temporal errors may be performed based on an array of the timestamp. When a plurality of identical timestamp values are present, duplication may be resolved by maintaining a value that has appeared first in a temporal order and removing subsequently repeated data of a same time point. Such removal of the duplication is performed when data is sorted along a time axis, and when a plurality of observation values are present for a particular time, processing is performed such that only a single value remains not to damage consistency of the integrated database.

In addition, when data at an earlier time appears after data that should appear later in a temporal order, it may be determined that a time series is in a reversed state. In the present embodiment, a timestamp array is validated in a temporal order, and when a past time point appears later compared to a preceding time point, a record corresponding to the past time may be determined as unstable data and removed. This process may be performed using a time-axis correction function or an algorithm equivalent thereto, and reconstructs an array state to satisfy continuity and monotonically increasing characteristics of a time array.

Such duplication and reversal corrections may be performed in a step of generating the first files for each observation point, and consistency may be verified based on a full time axis expected within a year-level time-resolution range. For example, a minute-level time array from a start time to an end time of a corresponding year may be set as a reference axis, and compared with a timestamp of actual observation data to identify a missing section, a duplication section, and a temporal order error section. This may re-sort and refine data to have a structure in which a time axis increases normally and monotonically.

As described above, by removing duplication and correcting an order based on a standardized timestamp, a time series for each observation point has a single and stable time structure. This may be used as a reference axis for extraction of weather elements, masking processing, calculation of a time-series integrity index, and calculation of a reliability index each to be performed in subsequent steps, and establishes a prerequisite for merging data from several observation points on a same time axis in integration and storage steps. As a result, an automatic time-axis error correction function operates as a main preprocessing step for ensuring structural stability of the integrated database.

A plurality of the first files may be stored by applying this process to all data collected from each urban weather observation network. In detail, a plurality of the first files corresponding to a number (nxy) obtained by multiplying a number (n) of all observation points included in the urban weather observation networks by a number (y) of observation periods on a yearly basis may be stored. For example, when a number of all observation points included in the four observation networks including the RWI observation network, the SEB observation network, the IMS observation network, and the UBG observation network is 40 (n=40) and observation periods are from Jan. 1, 2018 to Dec. 31, 2020 (y=3), a total of 120 first files in a CSV format may be stored.

At step S13, data at each observation point of the urban weather observation networks may be extracted from the stored first files according to an order of observation times with respect to a predetermined weather element and analysis period.

Here, the predetermined weather element may include at least one weather element selected from the group consisting of: air temperature, wind direction, wind speed, maximum wind direction, maximum wind speed, daily precipitation, air pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily temperature, maximum daily minimum temperature, daily maximum humidity, daily minimum humidity, daily maximum wind speed, and daily maximum wind direction.

In the present embodiment, the predetermined weather element may be selected after being converted from a raw variable name for each observation network into a standardized variable name and, even when observation networks are different, an observation value for a same physical quantity may be extracted by being sorted into a common variable name system. In addition, in a case of wind-related weather elements, an east-west component and a north-south component may be additionally calculated from wind direction and wind speed and provided, and values of the additionally calculated east-west and north-south components may be included within a same database structure along with wind-related variables of other observation networks as part of standardized weather elements. Accordingly, usability of direction-based statistical processing and spatial distribution analysis each required for urban weather analysis may be improved.

Here, the predetermined analysis period may include a yearly-based period. For example, the analysis period may be a yearly-based period such as 2018, 2019, or 2020.

The yearly-based analysis period may be set based on a minute-level temporal resolution from a start time to an end time of a corresponding year. As such, a structure in which the minute-level temporal resolution is set based on the yearly-based analysis period is not limited to a meaning of simple period division, but corresponds to a technical design intended to simultaneously secure efficiency of processing large-scale time-series data and structural stability of a database. In a case of urban weather data observed on a minute-level basis, since hundreds of thousands of time indices are generated for a single year alone, and a plurality of weather element values are combined for each time index, total data volume increases rapidly. Due to these characteristics, managing long-term accumulated data in a single file or structure may lead to problems such as reduced file input/output speed, increased memory usage, and an increased maintenance burden.

In the present embodiment, to mitigate these problems, data processing and storage units may be separated on a yearly basis. In detail, for each year, a continuous time axis based on a minute level from a start time to an end time of a corresponding year may be set as a reference array, and after data for each observation point is reconfigured to match the continuous time axis, the data may be stored as a year-based file. At this time, the time axis includes continuous minute-level indices from a first time point to a last time point of the corresponding year, and each index may be defined in a standardized timestamp format.

As described above, when the time axis is separated and stored on a yearly basis, data for a particular year may be selectively loaded and processed. Thus, loading of unnecessary data from other years during data reading and analysis may be prevented. In addition, even when maintenance tasks such as adding observation networks, adding observation points, or reprocessing data for a particular year are needed, only a file for the corresponding year may need to be modified. Thus, management efficiency is improved.

Further, a structure of the separation on the yearly basis may also be advantageous in a process of constructing an integrated database for each weather element. For example, even when a single integrated file is generated by merging data from a plurality of observation points with respect to a particular weather element, since the merging is performed based on files separated for each year, memory usage may be stably controlled. In addition, data generated on the yearly basis may be stored along with the time-series integrity index and the reliability index, and quality status of the data on the yearly basis may be managed independently.

A processing and storage format on the yearly basis has a structure for simultaneously ensuring scalability and ease of management of large-scale minute-level time-series data, and functions as a main design element configured to stably put, into a database, urban weather data accumulated over long periods. This may maintain temporal continuity for each observation point while achieving efficient use of computational resources and ease of maintenance.

For example, when a database is constructed based on a Python programming language, an analysis period for constructing the database may be designated, for example, as a list such as [‘2018’, ‘2019’, ‘2020’], and observation values for a predetermined weather element (e.g., wind speed) corresponding thereto may be extracted from the first files.

At step S15, among the observation values included in the extracted data, observation values corresponding to a predetermined masking condition may be masked.

In the present embodiment, step S15 is not limited to simply processing abnormal values as missing values, but may further include a process of calculating a time series integrity index by reflecting a result of the masking and a result of time series consistency correction together. The time series integrity index may include information comprehensively indicating, with respect to data of each observation point, whether continuity of a time axis is maintained, whether duplicate time values have been removed, whether data out of a temporal order has been removed, and whether stability of a time series array after masking is maintained. The time-series integrity index may be generated as a numerical value, a grade value, flag information, or a combination thereof, and may be provided to be included in a header or metadata of a second file in a subsequent step.

The time-series integrity index is not merely auxiliary information for referencing quality status, but may function as a main component of a database management structure according to the present embodiment. For example, the time-series integrity index may be calculated by comprehensively reflecting whether a year-level or minute-level time axis for a particular observation point exactly matches a reference array, a continuous length of a section in which actual data is not present relative to a reference time axis, a number of duplication removal operations at a same time, a number of removals of data out of a temporal order, and presence of sections in which valid values have significantly decreased due to masking. Unlike a simple missing data rate, the integrity index functions as an indicator for evaluating structural stability of data and consistency of a temporal array. For example, even when two observation points have a same valid data ratio, when one point has a concentrated loss of data during a particular time period and another point has some missing data evenly distributed over an entire period, the integrity index may classify the two points into different stability grades.

In addition, the integrity index may be actively used during a utilization phase of the integrated database. For example, when weather analysis of a particular urban area is performed, only observation points that satisfy preset integrity criteria may be automatically selected and included as an analysis target, and points having an integrity index equivalent to or below the preset integrity criteria may be assigned lower weights or classified as being excluded. Further, by comparing yearly-based integrity indices accumulated over a long period, aging trends of a particular observation device or recurring patterns of time-axis errors may be identified. As described above, a database according to present embodiment is not limited to a structure in which data is merely stored and managed, but may be implemented as an integrity-centered data management system configured to continuously check and quantitatively manage structural soundness of time series. This has technical significance in ensuring reliability and reproducibility of urban weather data.

The time series integrity index is distinguished from a result of calculating a simple missing data rate, and may be implemented as an integrated indicator for quantitatively evaluating stability of a time axis structure and consistency of data arrangement. For example, structural stability of a time series may be evaluated by reflecting a ratio of actual present time indices relative to a reference time axis with respect to a particular observation point, a number of duplication removal operations, a ratio of records removed as being determined as temporal-order errors, and a length of sections in which missing data is present consecutively after masking. In addition, the time series integrity index may be calculated by being subdivided according to time periods, and may be utilized as auxiliary information for identifying abnormal phenomena that have occurred intensively during a particular period. This configuration enhances quality management functions of the integrated database by determining validity of data values, as well as taking into account structural completeness of a time array.

The time series integrity index may be interpreted in association with the reliability index. For example, even when a valid data ratio is high, when time-axis gaps occur frequently, this may be set to be classified into a lower grade. On the other hand, even when a masking ratio is present at a certain level, when a time axis is maintained stably, this may be evaluated such that structural reliability is secured. Such composite evaluation results may not only be stored in a form of numerical values, but may also be converted into grade values such as normal, caution, and unstable or into reference flags and provided accordingly. The time series integrity index, obtained as a final result, is stored in a metadata area of the second file, and may be used in a subsequent analysis phase for selecting an observation point, assigning data weights, setting quality filtering criteria, etc.

In additional embodiments, a learning-based correction module based on past observation history may be further included to correct slight observation errors caused by sensor contamination, device aging, or changes in a surrounding environment. The learning-based correction module may calculate a value of correction by estimating tendency of underestimation or overestimation that repeatedly occurs in a particular sensor. A result of the correction may be applied by directly replacing a raw observation value, or provided as a separate correction candidate value or quality flag information. However, a process of constructing a basic database in the present embodiment may be implemented merely by performing time axis consistency correction, variable name standardization, masking, and quality indicator calculation each described above, and the learning-based correction module may be optionally combined.

The learning-based correction module is distinguished from a simple abnormal value detection function, and may be implemented as a structure configured to estimate a systematic bias of a particular sensor by utilizing long-term accumulated normal observation history as training data. For example, when low solar radiation is consistently recorded at a same observation point over a certain period than at adjacent observation points, this may indicate underestimation tendency caused by sensor surface contamination or sensitivity degradation. In this case, a regression model or a time series prediction model may be constructed based on past normal period data, and a correction coefficient may be calculated by analyzing a deviation between a present observed value and a predicted value. The correction coefficient may be set to be applied only within a certain threshold range, and for distinction from actual weather phenomena caused by rapid environmental changes, data from adjacent observation points or correlations between multiple weather elements may be taken into account together.

In addition, the learning-based correction module may operate in association with an integrity management structure of a database. For example, when the time-series integrity index at a particular observation point is satisfactory but the reliability index repeatedly deteriorates, this may indicate that although a time-axis structure is stable, a problem in sensor measurement accuracy is present. When such a pattern persists over a certain period, the learning-based correction module may be automatically activated to estimate a bias and generate candidate correction values. The generated correction values may not replace raw values, but be stored together with the raw values in a separate field to be selectively applied by a user. Alternatively, the generated correction values may be provided in a form of quality flags to be used for weight adjustment during an analysis phase. As such, the learning-based correction module may be implemented as an extension module that may be separated from the process of constructing the basic database and selectively combined to improve long-term data reliability.

The masking at step S15 is fundamentally distinguished from a method in which a human expert visually reviews observation values to determine whether the observation values are abnormal values. Masking conditions in the present embodiment correspond to sensor malfunction signature detection rules derived from physical measurement principles and limitations of each sensor arranged in the urban weather observation network, and sensor failure patterns repeatedly observed in actual operating environments. In detail, a negative value for wind speed indicates a sensor polarity reversal error occurring in an ultrasonic or mechanical anemometer, a wind speed value exceeding 75 m/s corresponds to a saturation fault exceeding a measurement saturation limit of an ultrasonic anemometer, and a sudden change value with a difference exceeding 10 m/s compared to an immediately previous observation value corresponds to abnormal reception due to a data communication error that occurs in a minute-level data collection process. Values below −90 °C or above 60 °C for air temperature indicate a calibration failure or an open circuit condition in a temperature sensor of a thermocouple or platinum resistance thermometer (PT100) type. The masking conditions cannot be consistently applied in real time across large-scale time-series data corresponding to dozens of observation points over multiple years with minute-level resolution when using a method manually performed by human. Only when the masking conditions are automated and executed by a computer system, a practical urban weather database may be constructed. Therefore, the masking in the present embodiment corresponds to specialized technical processing that cannot be reduced to a human mental process, but automatically detects a failure state of a physical sensor system to convert raw observation data into reliable and physically valid observation data.

Here, when the weather element predetermined at step S13 is wind speed, a predetermined masking condition may be masking, as missing values (e.g., 9999, NaN, etc.), negative values, values exceeding 75, and values of which a difference from an immediately previous observation value (e.g., 10 minutes before) is greater than 10, among extracted observation values.

Additionally or alternatively, when the weather element predetermined at step S13 is air temperature, the predetermined masking condition may be masking, as missing values, values smaller than −90 and values greater than 60 among the extracted observation values.

Additionally or alternatively, when the weather element predetermined at step S13 is neither wind speed nor air temperature, the predetermined masking condition may be masking, as missing values, negative values among the extracted observation values.

As described above, by masking all observation values corresponding to values unlikely to occur in urban areas in Korea in a real physical world as missing values, reliability of urban weather observation data used for analyzing actual urban weather phenomena may be improved. In addition, such inconvenience that a user of the database needs to apply separate filtering, masking, and the like may be resolved.

Additionally, in the present embodiment, a reliability index may be generated by calculating a ratio of normal observation values to total observations values for masked data. The reliability index represents a ratio of observation values that may be used for actual analysis after performing masking with respect to a particular weather element and observation points, and may be used as reference information for quantitatively comparing usability of data for each observation point. The reliability index may be, as needed, rounded to a nearest decimal place and stored, and provided to database users in a form of header information or separate metadata.

The reliability index is not merely a statistical value for calculating a ratio of missing values, but may also function as a quantitative criterion for determining whether a particular weather element is at a level suitable for actual analysis and modeling. For example, when a significant portion of precipitation data at a particular observation point is masked for a certain period, a result of precipitation analysis for the corresponding period may be statistically distorted. Thus, usability may be evaluated in advance through the reliability index. On the other hand, when a reliability index of temperature data remain at a high level during the same period, the temperature data may be classified as data suitable for analysis. As such, a reliability index calculated individually for each weather element may function as criteria for distinguishing usability of each element even within the same observation point.

In addition, the reliability index may be utilized as a standardized measure that enables comparison between observation points. For example, when a reliability index for wind speed data at a particular point among several observation points within a same city is calculated to be relatively low, this may be used as a basis for determining that sensor state check or maintenance is needed at the corresponding point. Further, by tracking changes in the reliability index calculated over multiple years, performance degradation trends of a particular device or patterns of error occurrence for each season may be identified. This structure enables a database to function not merely as a simple storage, but as a management system configured to continuously monitor a state of an observation device and data quality.

In particular, the reliability index in the present embodiment may be interpreted in combination with the time series integrity index. For example, a case in which a time axis is maintained normally but a masking rate is high and a case in which a masking rate is low but a time-axis gap is present have different quality characteristics. In the former case, the reliability index directly represents a ratio of valid values available for analysis, whereas in the latter case, the time series integrity index represents structural stability. By taking into account the two indices together, a dual quality verification system configured to simultaneously evaluate structural stability of data and validity y of values is established.

Further, the reliability index may be utilized as data selection criteria in an automated analysis system. For example, the reliability index may be set to be included as model training data only when a particular threshold is satisfied, or utilized by applying differential weights according to a level of reliability. In addition, the reliability index may be visualized on a user interface to allow a user to intuitively identify quality status of each observation point and weather element. As such, the reliability index operates not merely as a simple statistical value, but as a main management structure configured to support data utilization decision-making, and clearly indicates that the database in the present embodiment implements a quality-oriented management system.

The time series integrity index and the reliability index are not merely auxiliary statistical values for referencing data quality status, but function as machine-readable quality control information that enables an analysis system or a user system accessing the second file to automatically determine whether to utilize data for each observation point. For example, automated data selection and weight assignment may be performed in a system using the second file such that only data from observation points with the time-series integrity index equal to or greater than a preset reference value is automatically selected and used as input data for a subsequent weather analysis model, or, differential analysis weights are applied according to the reliability index. As described above, the configuration of including the time-series integrity index and the reliability index as header information in the second file corresponds to a technical improvement in the database structure such that a subsystem using the integrated database may immediately determine usability of data without separate additional quality verification. This corresponds to a practical application distinguished from a mathematical operation of simple ratio calculation.

At step S17, the masked data may be stored as one second file. The second file may further include, as header information, a ratio of non-missing values (i.e., normal observation values) among all observation values (i.e., all observation values before being masked) with respect to a predetermined weather element (e.g., wind speed). For example, in a case of wind speed among observation values of weather elements collected from a particular observation point, excluding missing values among observation values between Jan. 1, 2018 and Dec. 31, 2020, a value of 80.76, which indicates that only 80.76% of observation values during the entire 3-year analysis period are actual observation values, may be included in the header information.

In addition, the second file may include the time-series integrity index along with the reliability index as header information or metadata. For example, in a header of the second file, observation point identification information, location information, altitude information, and the reliability index and the time series integrity index of the weather element may be recorded together. Thus, a database user may check not only an observation value of a particular observation point but also time series consistency and usability. Accordingly, in a subsequent analysis phase, data quality for respective observation points may be compared with each other and selected without separate additional verification.

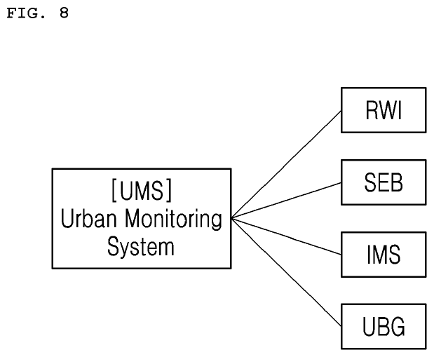

FIG. 8 is a view conceptually showing an architecture of the urban customized weather database integrated using the integrated management method of the urban customized weather database according to an embodiment of the present disclosure. Referring to FIG. 8, it may be understood that the urban customized weather database constructed by the integrated management method of the urban customized weather database may be implemented in a way of integrating data from four urban weather observation networks operated for different purposes into one database.

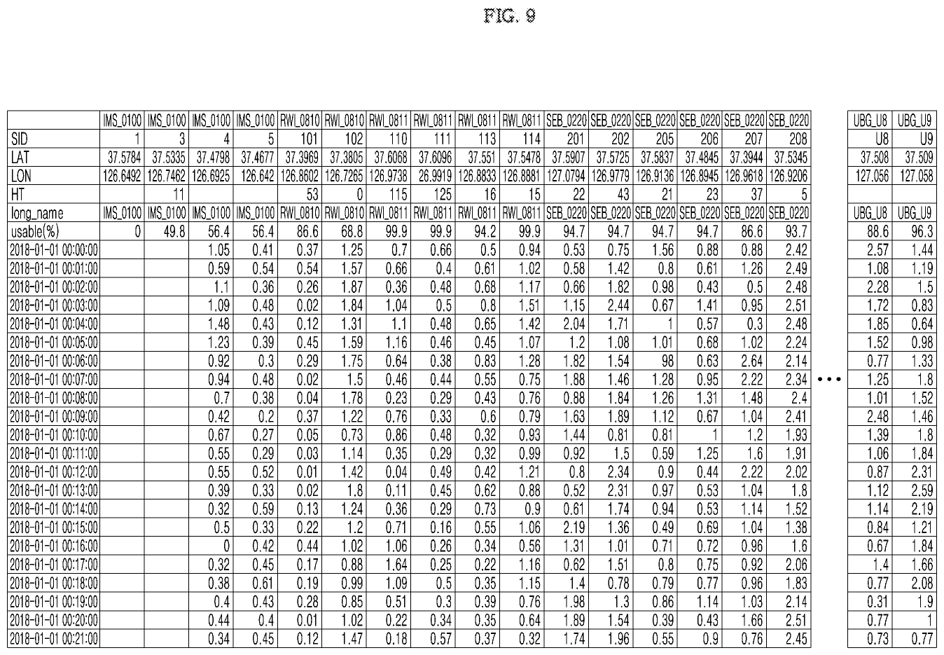

FIG. 9 is a view showing one example of a weather element database constructed according to the integrated management method of the urban customized weather database according to an embodiment of the present disclosure. Referring to FIG. 9, an ID, a latitude (LAT), a longitude (LON), a height, and a ratio (usability) of available observation values of each observation point are included as a header file with respect to each observation point (column title) of four observation networks including the RWI, SEB, IMS, and UBG observation networks, and observation values of wind speed observed from 00:00 on Jan. 1, 2018 to 23:59 on Dec. 31, 2020 may be stored in one file (e.g., CSV file).

At this time, such header information may include a time series integrity index in addition to the ratio of the available observation values, and the time series integrity index may be provided as quality information that reflects results of time axis consistency correction and masking of data at a corresponding observation point. In addition, raw variable names for each observation network may be organized and stored as standardized variable names according to a predefined mapping table. Thus, comparison may be performed based on common weather elements between observation points belonging to different observation networks within the same file structure.

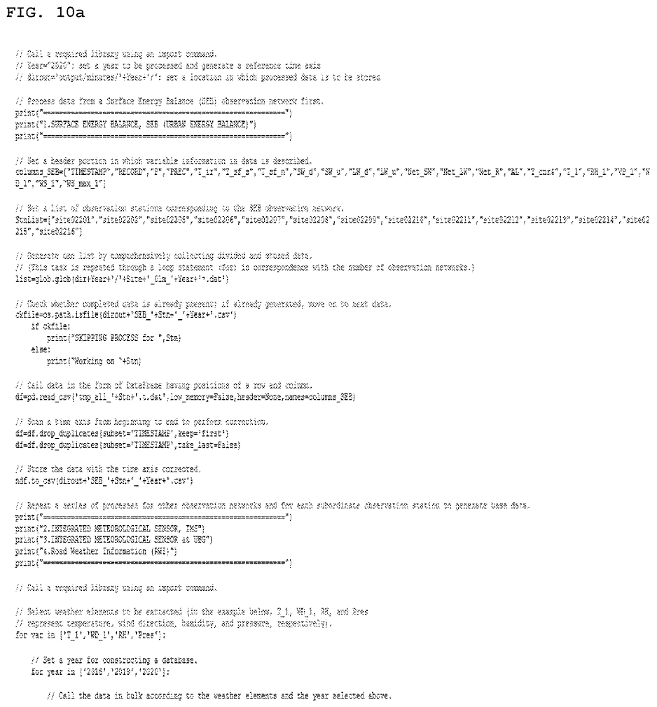

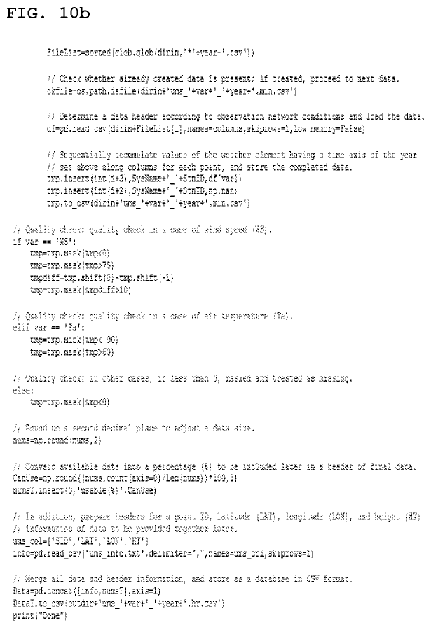

FIGS. 10a and 10b are views showing a Python-based pseudo code for implementing the integrated management method of the urban customized weather database according to an embodiment of the present disclosure. Referring to FIGS. 10a and 10b, based on Python programming language, urban weather observation data collected from different urban weather observation networks may be constructed as a database of a desired weather element and analysis period.

In such a Python-based implementation, file reading for each observation network, time axis standardization, variable name mapping, weather element extraction, masking, calculation of the time series integrity index, calculation of the reliability index, and storage of an integrated file may be performed sequentially. In addition, by applying a processing structure for each observation point on a yearly basis, memory usage and file management complexity during processing may be reduced even with respect to large-scale minute-level time-series data. This may be advantageous for maintenance tasks of selectively reprocessing only data from a particular observation network or a particular observation point.

Such an implementation structure described above is not limited to a mere software execution procedure, but corresponds to a technical configuration closely related to a data structure design of structuring and processing large-scale minute-level time-series data for each observation point on a yearly basis. That is, respective phases including file separation for each observation a network, setting of standardized time-axis index, rearrangement of standard variable headers, verification of time-series consistency, and parallel calculation of integrity and reliability indices are a process of structurally rearranging and refining raw signals collected from physical sensors to perform concrete time-series structural transformation beyond a simple abstract data processing concept. This configuration functions as a technical means for solving structural problems of large-scale and high-resolution time-series data generated in a technical field of urban weather observation.

In addition, a processing structure in the present embodiment has a significance of implementing a series of technical processing flows in which minute-level time-series data based on a time axis is stably reconstructed, heterogeneous sensor headers are converted into a standard system, and stability of an observation device and data structures is quantified. The Python-based implementation is merely one embodiment for implementing the processing structure, and the same time-axis standardization structure, a variable mapping scheme, integrity index calculation logic, and a reliability management scheme may be implemented identically in other execution environments. Therefore, the present embodiment is not a simple information processing procedure, but rather a technical database construction method for improving structural stability and usability of data generated from a physical weather observation system.

The integrated management method of the urban customized weather database according to the present embodiment is fundamentally distinguished from weather data processing systems, in the related art, configured to simply collect, display, or report weather data. Weather database systems in the related art are generally designed to process data from a single observation network or observation devices having a same header structure, and thus, unlike the present embodiment, fail to solve a technical problem of structuring data from multiple heterogeneous observation networks, which differ in an installation purpose, a device manufacturer, and a header structure, based on a single integrated time axis and a common header schema. The present embodiment provides a database construction method in which four technical components are organically combined, the four technical components including: (i) mapping table-based standardization that converts heterogeneous headers into a common header schema, (ii) time series structure transformation based on a minute-level monotonically increasing timestamp, (iii) physical validity verification and masking based on sensor malfunction signature detection rules, and (iv) a second file structure including a time series integrity index and a reliability index as machine-readable header information. This combination corresponds to a specific technical solution that cannot be obviously derived from the related art, in a technical field of urban weather observation. In particular, the second file generated as a result of processing in the present embodiment is not merely a storage or display of raw data, but is a result of converting raw data having a heterogeneous structure into an analysis-ready database record including all of an integrated time axis, a common header, results of physical validity verification, and structural quality indicators. This corresponds to a state qualitatively different from the raw data.

According to the method and system for managing an urban customized weather database in an integrated manner according to the present disclosure, observation data collected from different urban weather observation networks may be stored as sorted and integrated data, and accordingly, users may easily access and use urban weather data.

As described above, the Python-based integrated management method of an urban customized weather database according to the embodiments of the present disclosure may be configured to be implemented by a computing system. Although the computing system may include, for example, a server, a desktop computer, a notebook computer, a workstation, a personal digital assistant (PDA), a mainframe, one or more various types of digital computing devices, and the like, it is not limited thereto.

The computing system may include one or more processors, one or more memories, and the like. Each of the processors, memories, and the like may be interconnected using various wired/wireless communication means and/or buses. According to embodiments, a plurality of processors and/or a plurality of memories may be used, or a plurality of computing devices may be connected to be able to communicate. Each computing device is, for example, a server, a group of servers, or a multi-processor system, and may provide some of necessary operations. When a plurality of functions and/or operations is performed by the processor(s), the plurality of functions and/or operations may be performed by an arbitrary number of processors included in an arbitrary number of computing devices. In addition, when a function and/or an operation is performed by a processor(s), the function and/or operation may be executed by, for example, an arbitrary number of processors included in an arbitrary number of computing devices in a distributed computing system.

The memory(s) may be non-volatile memory unit(s) for storing information in a computing system. The memory(s) may be or include, for example, a floppy disk, a hard disk, a magnetic disk, an optical disk, a magnetic tape, a flash memory, a solid-state memory, various forms of computer readable media, or the like.

One or more of methods as described above may be configured to be implemented when instructions stored in the memory(s) are executed by the one or more processor(s). These methods may be implemented by a digital electronic circuit, an integrated circuit, an application specific integrated circuit (ASIC), computer hardware, firmware, software, and/or a combination of these. These various implementations may include implementations on one or more computer programs executable and/or interpretable on a programmable system including at least one programmable processor configured to execute the instructions.

These computer programs (also referred to as programs, software, software applications, or codes) may be implemented in a high-level procedure-oriented and/or object-oriented programming language, and/or in an assembly/machine language.

Components of different embodiments described in the present disclosure may be combined to form other embodiments not specifically described above. The components may be excluded from the processes, computer programs, databases, and the like described in the embodiments of the present disclosure without affecting the functions and/or operations thereof.

In addition, logical flows illustrated in the drawings do not require a specific order or a sequential order shown in the drawings to achieve a desirable result. It should be understood that the order for performing a specific operation or the order of steps is not important as long as the embodiments described in this disclosure are maintained to be operable. In addition, two or more steps or operations may be performed simultaneously.

Although the embodiments described in the present disclosure have been shown and described in connection with specific embodiments, those skilled in the art should understand that various changes may be made in the form and detailed descriptions without departing from the idea and scope of the claims as defined by the appended claims.

What is claimed is:

1. A Python-based integrated management method of an urban customized weather database, the method for constructing urban weather observation data into an integrated database and comprising the steps of:
storing, as first files in a predetermined format, raw urban weather observation data collected from a plurality of urban weather observation networks, the raw urban weather observation data being arranged for each observation point of the plurality of urban weather observation networks on a yearly basis according to a standardized time-axis index (timestamp) based on minute-level temporal resolution from 00:00 on January 1 to 23:59 on December 31 of a corresponding year;
extracting data for each observation point of the plurality of urban weather observation networks from the first files, obtained by the storing, based on the timestamp with respect to a predetermined weather element and analysis period;
masking, as missing values, observation values that fall under predetermined masking conditions corresponding to sensor malfunction signature detection rules derived from physical measurement limits of sensors arranged in the plurality of urban weather observation networks and from urban atmospheric conditions, among observation values comprised in the extracted data, and calculating a time-series integrity index comprehensively indicating whether continuity of a time axis is maintained, whether duplicate time values are removed, whether duplicate time values have been removed, whether time-reversed data is removed, and whether stability of a time series array is ensured after the masking;
generating a reliability index by calculating, for the masked data, a ratio of valid observation values that are not masked among all observation values; and
storing, as a second file, the masked data comprising the time-series integrity index and the reliability index as header information,
wherein the storing as the first files comprises:
when a plurality of observation values are present at each observation point with respect to one weather element at a same observation time, storing only an observation value that was collected first in a temporal order among the plurality of observation values with respect to the one weather element, and removing remaining observation values; and
for each observation point, automatically detecting and removing time-reversed data in which a time point earlier than a preceding time point appears at a subsequent position, to cause an array of the timestamp to maintain a monotonically increasing structure,
the raw urban weather observation data comprises data that, when observation variable names for a same physical quantity are defined differently depending on the plurality of urban weather observation networks, have been converted into standardized variable names in a common header schema that enables integrated analysis between observation networks based on a predefined mapping table in which raw variable names for each observation network correspond to standardized variable names,
the plurality of urban weather observation networks comprises a road weather information (RWI) observation network, a surface energy balance (SEB) observation network, an integrated meteorological sensor (IMS) observation network, and an urban-boundary-green (UBG) observation network each operated by the National Institute of Meteorological Sciences,
the predetermined format comprises a comma separated value (CSV) format,
the first files are stored in a plurality in correspondence with a number (nxy) obtained by multiplying a number (n) of all observation points comprised in the plurality of urban weather observation networks by a number (y) of observation periods on a yearly basis, and
the predetermined masking conditions corresponding to the sensor malfunction signature detection rules comprise:
when the predetermined weather element is wind speed, masking, as missing values, a negative observation value corresponding to an anemometer reversal error, an observation value exceeding 75 m/s in correspondence with a saturation failure of an ultrasonic anemometer, and an observation value in correspondence with abnormal reception due to a data communication error and with a difference exceeding 10 m/s compared to an immediately preceding observation value;
when the predetermined weather element is air temperature, masking observation values less than −90 °C and observation values exceeding 60 °C, each in correspondence with a thermometer calibration failure, as missing values; and
when the predetermined weather element is neither wind speed nor air temperature, masking negative observation values corresponding to instrument malfunction states as missing values.

2. The method according to claim 1, wherein the predetermined weather element comprises at least one weather element selected from a group consisting of: air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, and daily maximum wind direction.

3. The method according to claim 1, wherein the first files have a unified columnar structure comprising a metadata area comprising an observation point identifier, latitude, longitude, and altitude, and a weather element area aligned according to the common header schema, and
the unified columnar structure is configured such that data from heterogeneous observation networks are directly merged and retrieved without additional format conversion.

4. The method according to claim 1, wherein the time series integrity index is configured to:
be calculated by reflecting a ratio of actually existing time indices relative to a reference time axis, a number of duplication removal operations, a ratio of records removed as being determined as time-series reversals, and a length of sections in which missing values occur consecutively after the masking; and
in combination with the reliability index, enable a user system accessing the second file to automatically determine whether to utilize data for each observation point based on the time-series integrity index and the reliability index.

5. A computing system comprising a processor and a memory, the memory being configured to store computer-readable instructions that, when executed by the processor, cause the processor to:
store, as first files in a predetermined format, raw urban weather observation data collected from a plurality of urban weather observation networks, the raw urban weather observation data being arranged for each observation point of the plurality of urban weather observation networks on a yearly basis according to a standardized time-axis index (timestamp) based on minute-level temporal resolution from 00:00 on January 1 to 23:59 on December 31 of a corresponding year;
extract data for each observation point of the plurality of urban weather observation networks from the first files, obtained by the storing, based on the timestamp with respect to a predetermined weather element and analysis period;
mask, as missing values, observation values that fall under predetermined masking conditions corresponding to sensor malfunction signature detection rules derived from physical measurement limits of sensors arranged in the plurality of urban weather observation networks and from urban atmospheric conditions, among observation values comprised in the extracted data, and calculate a time-series integrity index comprehensively indicating whether continuity of a time axis is maintained, whether duplicate time values are removed, whether duplicate time values have been removed, whether time-reversed data is removed, and whether stability of a time series array is ensured after the masking;
generate a reliability index by calculating, for the masked data, a ratio of valid observation values that are not masked among all observation value; and
store, as a second file, the masked data comprising the time-series integrity index and the reliability index as header information,
wherein the storing as the first files comprises:
when a plurality of observation values are present at each observation point with respect to one weather element at a same observation time, storing only an observation value that was collected first in a temporal order among the plurality of observation values with respect to the one weather element, and removing remaining observation values; and
for each observation point, automatically detecting and removing time-reversed data in which a time point earlier than a preceding time point appears at a subsequent position, to cause an array of the timestamp to maintain a monotonically increasing structure,
the raw urban weather observation data comprises data that, when observation variable names for a same physical quantity are defined differently depending on the plurality of urban weather observation networks, have been converted into standardized variable names in a common header schema that enables integrated analysis between observation networks based on a predefined mapping table in which raw variable names for each observation network correspond to standardized variable names,
the plurality of urban weather observation networks comprises a road weather information (RWI) observation network, a surface energy balance (SEB) observation network, an integrated meteorological sensor (IMS) observation network, and an urban-boundary-green (UBG) observation network each operated by the National Institute of Meteorological Sciences,
the predetermined format comprises a comma separated value (CSV) format,
the first files are stored in a plurality in correspondence with a number (nxy) obtained by multiplying a number (n) of all observation points comprised in the plurality of urban weather observation networks by a number (y) of observation periods on a yearly basis, and
the predetermined masking conditions corresponding to the sensor malfunction signature detection rules comprise:
when the predetermined weather element is wind speed, masking, as missing values, a negative observation value corresponding to an anemometer reversal error, an observation value exceeding 75 m/s in correspondence with a saturation failure of an ultrasonic anemometer, and an observation value in correspondence with abnormal reception due to a data communication error and with a difference exceeding 10 m/s compared to an immediately preceding observation value;
when the predetermined weather element is air temperature, masking observation values less than −90 °C and observation values exceeding 60 °C, each in correspondence with a thermometer calibration failure, as missing values; and
when the predetermined weather element is neither wind speed nor air temperature, masking negative observation values corresponding to instrument malfunction states as missing values.
